(19) United States
(12) Patent Application Publication
(10) Pub. No.: US 2026/0070614 A1
(43) Pub. Date: Mar. 12, 2026

(54) VEHICLE BODY STRUCTURE

(71) Applicants: HYUNDAI MOTOR COMPANY, Seoul (KR); KIA CORPORATION, Seoul (KR)

(72) Inventors: Seung Min Kang, Hwaseong-si (KR); Dong Kyu Kim, Hwaseong-si (KR); Je Joon Lee, Hwaseong-si (KR)

(73) Assignees: HYUNDAI MOTOR COMPANY, Seoul (KR); KIA CORPORATION, Seoul (KR)

(21) Appl. No.: 19/057,604

(22) Filed: Feb. 19, 2025

(30) Foreign Application Priority Data
Sep. 12, 2024 (KR) 10-2024-0124943

(51) Int. Cl. B62D 25/14; B60N 2/005; B62D 25/04; B62D 25/08; B62D 25/16; B62D 25/20

(52) U.S. Cl. CPC B62D 25/145; B60N 2/005; B62D 25/04; B62D 25/081; B62D 25/088; B62D 25/16; B62D 25/2018

(57) ABSTRACT

A vehicle body structure includes: a dash panel including an incline part extending to be inclined forward and upward from a floor; and an upright part extending upward from the incline part; front side members disposed on two opposite front sides of a vehicle body and extended in a longitudinal direction of the vehicle body; a suspension support member disposed on an upper side of the front side member, configured to support a suspension device, and having a rear portion supported on the incline part; and an inclined upper longitudinal member configured to support the rear portion of the suspension support member, and disposed to overlap the suspension support member with the incline part interposed therebetween. The inclined upper longitudinal member is configured to extend in the longitudinal direction along an inclination of the incline part.

### CROSS-REFERENCE TO RELATED APPLICATION

This application claims priority to Korean Patent Application No. 10-2024-0124943, filed on Sep. 12, 2024, the entire contents of which are incorporated herein by reference.

### BACKGROUND

### Field of the Disclosure

The present disclosure relates to a technology related to a front structure of a vehicle body.

### Description of the Related Art

A purpose-built vehicle (PBV) refers to a vehicle capable of being configured by a combination of a drive module for driving the vehicle and a life module for defining passenger and loading spaces having various shapes in accordance with the market requirements to align with the market trend of diversified, small-quantity production.

Therefore, the PBV offers an advantage of enabling quick production of vehicles that meets the market requirements, only by changing the life module.

The PBV is designed to minimize the overall vehicle length while extending the wheelbase and positioning the driver's seat as far forward as possible, aiming to improve space utilization for passengers or cargo (e.g., a space for baggage) and reduce production costs.

Because of the above-mentioned development trends, it is difficult to ensure a sufficient space for preparing for a frontal collision accident at a front side of the PBV.

The foregoing explained as the background is intended merely to aid in the understanding of the background of the present disclosure, and is not intended to mean that the present disclosure falls within the purview of the related art that is already known to those having ordinary skill in the art.

### SUMMARY

The present disclosure is proposed to solve these problems and aims to provide a vehicle body structure, in which seats in a first row, including a driver seat, are positioned as far forward as possible within the vehicle body (e.g., at a front side of a vehicle body) to maximize an interior space in a PBV or similar vehicle, such that even in a vehicle having difficulty in ensuring a sufficient space for absorbing collision energy in the event of a frontal collision accident at a front side of a vehicle body, collision energy generated by a frontal collision may be effectively dispersed and supported, which may ensure sufficient safety performance for preparing for a frontal collision of the vehicle.

Technical problems to be solved by the present disclosure are not limited to the above-mentioned technical problems, and other technical problems, which are not mentioned above, may be clearly understood from the following descriptions by those having ordinary skill in the art to which the present disclosure pertains.

In order to achieve the above-mentioned object, the present disclosure provides a vehicle body structure. In one embodiment, the vehicle body structure includes a dash panel including an incline part extending to be inclined forward and upward from a floor, and an upright part extending upward from the incline part. The vehicle body structure further includes: front side members disposed on two opposite front sides of a vehicle body and extended in a longitudinal direction of the vehicle body; and a suspension support member disposed on an upper side of the front side member, configured to support a suspension device, and having a rear portion supported on the incline part. The vehicle body structure further includes an inclined upper longitudinal member configured to support the rear portion of the suspension support member, disposed to overlap the suspension support member with the incline part interposed therebetween, and extended in the longitudinal direction along an inclination of the incline part.

In one embodiment, the vehicle body structure further includes a side support longitudinal member configured to support the rear portion of the front side member. A rear portion of the front side member may be coupled to the incline part, and the side support longitudinal member may overlap the front side member with the incline part interposed therebetween, and extend in the longitudinal direction along the inclination of the incline part.

In one embodiment, the vehicle body structure further includes a dash upper cross member disposed at a boundary between the upright part and the incline part of the dash panel and configured to extend in a transverse direction of the vehicle body. The dash upper cross member may be configured to overlap the suspension support member with the dash panel interposed therebetween to support a rear upper side of the suspension support member.

The vehicle body structure may further include: a dash middle cross member spaced apart rearward and downward from the dash upper cross member, extended in the transverse direction of the vehicle body, and coupled to the incline part, in which the inclined upper longitudinal member is configured to connect the dash upper cross member and the dash middle cross member.

The dash middle cross member may be disposed to overlap a rear upper side of the front side member with the incline part interposed therebetween to support the rear portion of the front side member.

In one embodiment, the vehicle body structure further includes a plurality of inclined lower longitudinal members that may be connected to the dash middle cross member, extended in the longitudinal direction along the inclination of the incline part, and connected to the floor from the dash middle cross member.

The dash middle cross member and the plurality of inclined lower longitudinal members may be integrated.

The plurality of inclined lower longitudinal members may be provided in two pairs, respectively, on opposite sides (i.e., two pairs on one side and two pairs on the other side) based on a center of the vehicle body based on the transverse direction, and the side support longitudinal member may be disposed between the two inclined lower longitudinal members on any one side based on the center of the vehicle body based on the transverse direction.

A rear end of the side support longitudinal member may be connected to and supported by a dash lower cross member configured to be extended in the transverse direction of the vehicle body configured to connect the two adjacent inclined lower longitudinal members.

In one embodiment, the vehicle body structure further includes a seat mounting member that may be connected to a rear end of each of the inclined lower longitudinal members and extended in the longitudinal direction of the vehicle body.

A cowl cross bar may be coupled to an upper side of the dash middle cross member and extended in the transverse direction of the vehicle body, and two opposite ends of the cowl cross bar may be coupled to an A-pillar.

The cowl cross bar, the dash middle cross member, and the A-pillar may constitute an annular structure toward a front side of the vehicle.

The cowl cross bar may be coupled to the dash middle cross member by at least one cowl support member configured to connect the cowl cross bar and the dash middle cross member upward and downward and support the cowl cross bar and the dash middle cross member.

An additional inclined upper longitudinal member may be further provided between the two inclined upper longitudinal members and extended in the longitudinal direction along the inclination of the incline part to connect the dash upper cross member and the dash middle cross member.

The additional inclined upper longitudinal member may be rectilinearly aligned and disposed on front upper sides of the two inclined lower longitudinal members close to the center of the vehicle body based on the transverse direction among the plurality of inclined lower longitudinal members.

An additional dash cross member, which has a shape elongated toward an outside of the vehicle body in the transverse direction between the dash upper cross member and the dash middle cross member, may be connected to each of the two inclined upper longitudinal members.

The inclined upper longitudinal member may be coupled to extend to overlap the upper side of the side support longitudinal member, and the rear portion of the front side member may be configured to be supported by a dual closed cross-section made by the side support longitudinal member and the inclined upper longitudinal member.

The suspension support member may be formed in an ‘n’ shape in which two opposite ends thereof are coupled to be spaced apart from the front side member in the longitudinal direction.

The suspension support member may include: a first leg part having a lower end coupled to the front side member; a second leg part having a lower end coupled to the front side member at a rear side of the first leg part; and a leg connection part elongated in a longitudinal direction of the vehicle body and configured to connect the first leg part and an upper end of the second leg part.

The suspension support member may be coupled to a wheel house panel such that the leg connection part, the second leg part, and the first leg part of the suspension support member are connected to each other, forming a space between the suspension support member and the wheel house panel.

According to the present disclosure, the seats in the first row including the driver seat are disposed at the front side of the vehicle body if possible to maximize the interior space in the PBV or a similar vehicle, such that even in a vehicle having difficulty in ensuring a sufficient space for absorbing collision energy in the event of a frontal collision accident at a front side of a vehicle body, collision energy generated by a frontal collision may be effectively dispersed and supported, which may provide sufficient safety performance for preparing for a frontal collision of the vehicle.

The effects obtained by the present disclosure are not limited to the aforementioned effects, and other effects, which are not mentioned above, should be clearly understood by those having ordinary skill in the art from the following description.

### BRIEF DESCRIPTION OF THE DRAWINGS

FIG. 1 is a view illustrating a front structure of a vehicle body to which the present disclosure is applied.

FIG. 2 is a view illustrating FIG. 1 when viewed from the rear side.

FIG. 3 is a view illustrating only a dash panel in FIG. 2.

FIG. 4 is a view illustrating the dash panel in FIG. 3 when viewed from the front side.

FIG. 5 is a view illustrating a cross-section taken along line F5-F5 in FIG. 4.

FIG. 6 is a view illustrating a state in which the dash panel in FIG. 2 is removed.

FIG. 7 is a view illustrating FIG. 6 when viewed from the front lower side.

FIG. 8 is a view illustrating only a main part in FIG. 6.

FIG. 9 is a side view of FIG. 8.

FIG. 10 is a view illustrating FIG. 8 when viewed from the front lower side.

FIG. 11 is a top plan view of FIG. 8.

FIG. 12 is a view illustrating a state in which the dash panel is included in FIG. 7.

FIG. 13 is a view additionally illustrating an A-pillar and a cowl cross bar when FIG. 12 is viewed from a rear side of a vehicle body.

FIG. 14 is a view illustrating the cowl cross bar in FIG. 13 when viewed from a lateral side of a vehicle.

FIG. 15 is a view illustrating another embodiment of the present disclosure made by modifying the structure in FIG. 11.

FIG. 16 is a cross-sectional view taken along line F16-F16 in FIG. 11.

FIG. 17 is a view illustrating another embodiment of the present disclosure made by modifying the structure in FIG. 16.

### DETAILED DESCRIPTION OF THE DISCLOSURE

In the description of the embodiments disclosed in the present disclosure, the specific descriptions of publicly known related technologies have been omitted when it is determined that the specific descriptions may obscure the subject matter of the embodiments disclosed in the present specification. In addition, it should be interpreted that the accompanying drawings are provided only to allow those having ordinary skill in the art to easily understand the embodiments disclosed in the present disclosure, and the technical spirit disclosed in the present disclosure is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

Singular expressions include plural expressions unless clearly described as different meanings in the context.

In the present specification, it should be understood the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof.

The suffixes “module”, “unit”, “part”, and “portion” used to describe constituent elements in the following description are used together or interchangeably in order to facilitate the description, but the suffixes themselves do not have distinguishable meanings or functions.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

In addition, the term “control unit” or “unit” included in the name of “motor control unit (MCU)” or “hybrid control unit (HCU)” is merely a term widely used to name a control device (controller or control unit) for controlling a particular vehicle function but does not mean a generic function unit. When a component, device, element, or the like of the present disclosure is described as having a purpose or performing an operation, function, or the like, the component, device, or element should be considered herein as being “configured to” meet that purpose or to perform that operation or function.

A controller may include a communication device configured to communicate with another control unit or a sensor to control a corresponding function, a memory configured to store an operating system, a logic instruction, and input/output information, and one or more processors configured to perform determination, computation, decision, or the like required to control the corresponding function.

Hereinafter, embodiments disclosed in the present disclosure are described in detail with reference to the accompanying drawings. The same or similar constituent elements are assigned with the same reference numerals regardless of reference numerals, and the repetitive description thereof are omitted.

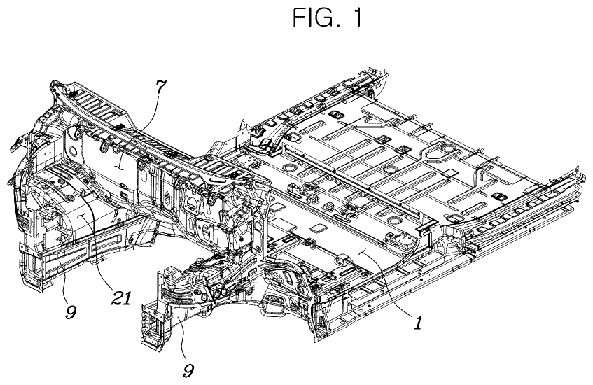

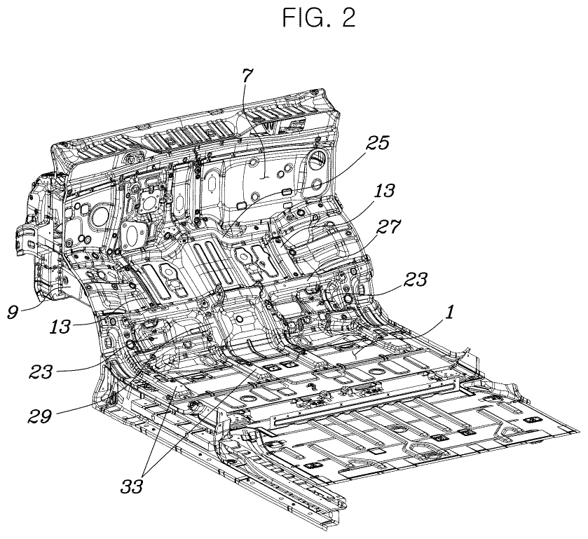

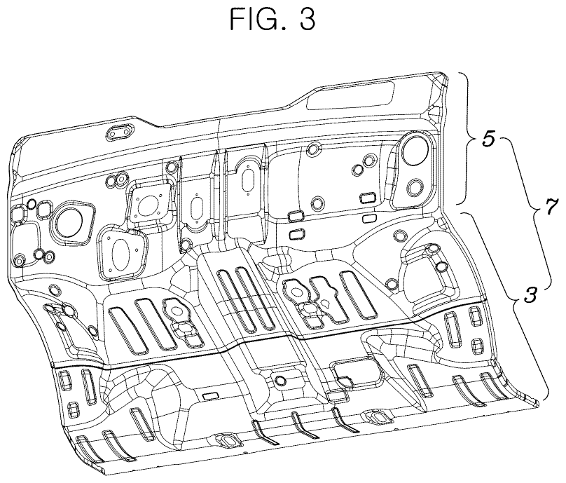

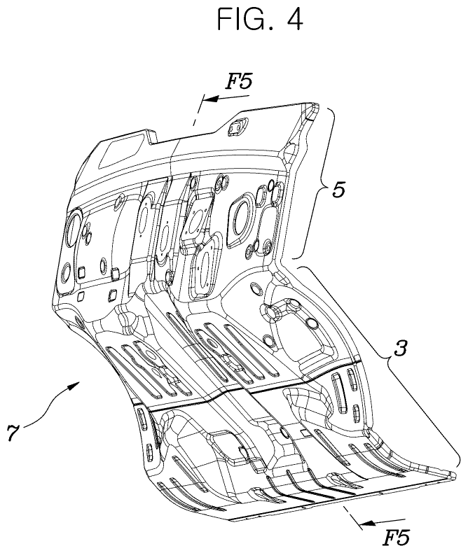

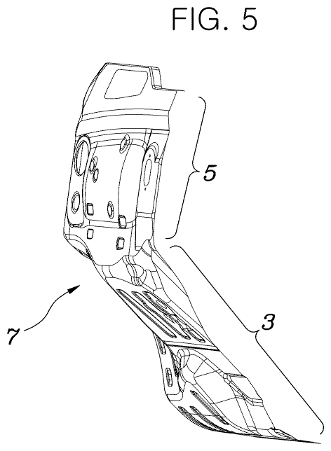

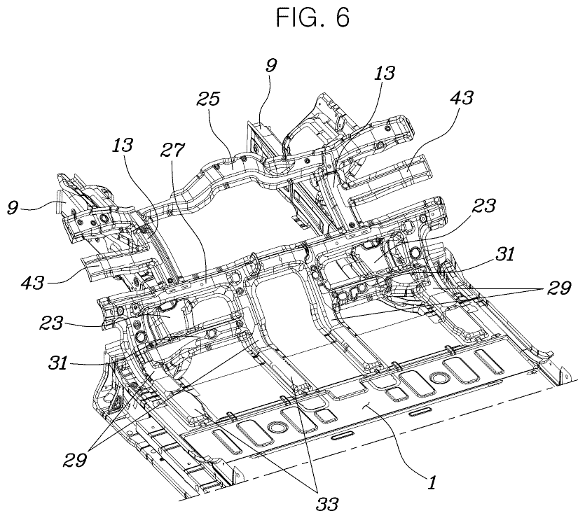

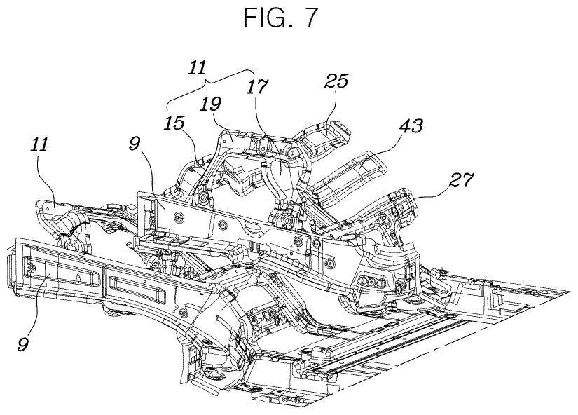

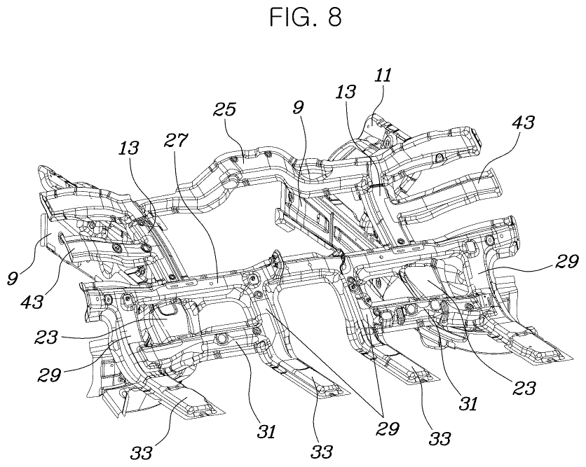

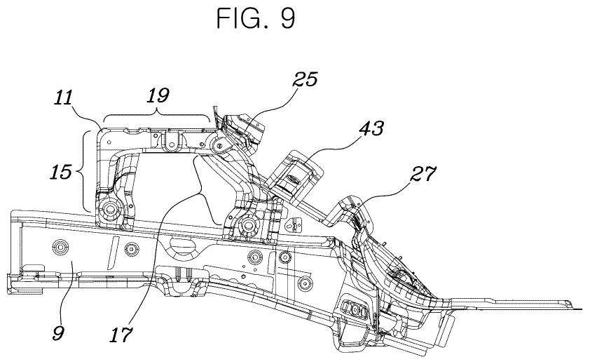

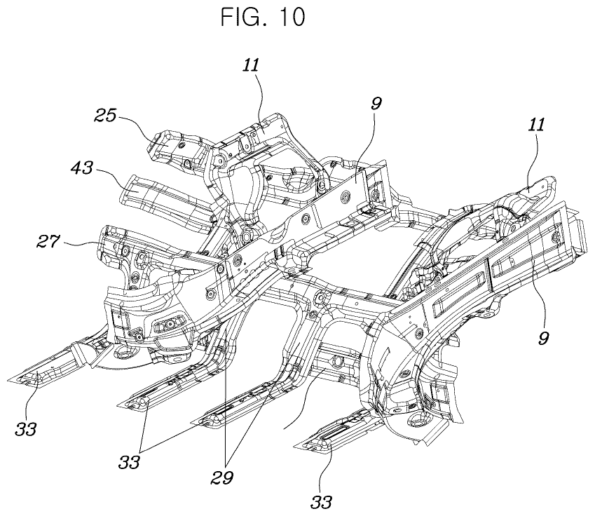

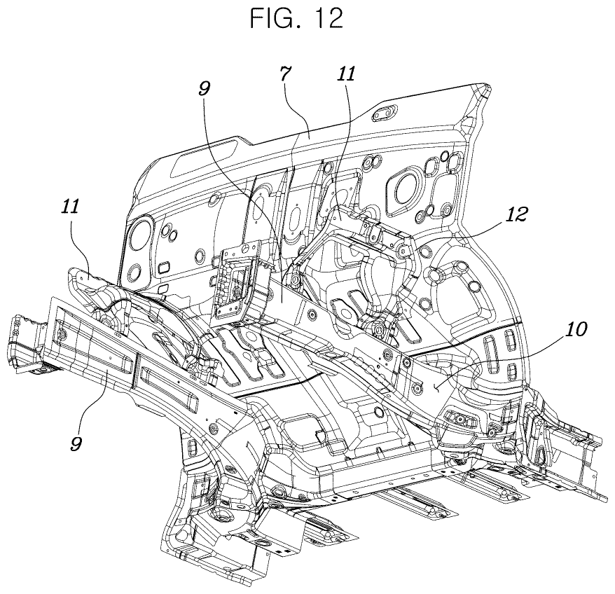

With reference to FIGS. 1 to 14, in an embodiment of according to the present disclosure, a vehicle body structure includes: a dash panel 7 including an incline part 3 extending to be inclined forward and upward from a floor 1, and an upright part 5 extending upward from the incline part 3; front side members 9 disposed on two opposite front sides of a vehicle body and elongated in a longitudinal direction of the vehicle body; a suspension support member 11 disposed on an upper side of the front side member 9, configured to support a suspension device, and having a rear portion supported on the incline part 3; and an inclined upper longitudinal member 13 configured to support the rear portion of the suspension support member 11, disposed to overlap the suspension support member 11 with the incline part 3 interposed therebetween, and elongated in the longitudinal direction along an inclination of the incline part 3.

In one embodiment, the rear portion 12 of the suspension support member 11 is supported on the incline part 3 of the dash panel 7, and the inclined upper longitudinal member 13 is installed to overlap the suspension support member 11 with the incline part 3 interposed therebetween, thereby effectively supporting an impact force transmitted rearward through the suspension support member 11 in the event of a frontal collision accident or the like of the vehicle.

The dash panel 7 may be configured by bending one panel or connecting a plurality of panels to constitute the incline part 3 and the upright part 5.

In one embodiment, the suspension support member 11 is formed in an ‘n’ shape in which two opposite ends thereof are coupled to be spaced apart from the front side member 9 in the longitudinal direction.

More specifically, the suspension support member 11 may include: a first leg part 15 having a lower end coupled to the front side member 9; a second leg part 17 having a lower end coupled to the front side member 9 at a rear side of the first leg part 15; and a leg connection part 19 elongated in a longitudinal direction of the vehicle body and configured to connect the first leg part 15 and an upper end of the second leg part 17.

The suspension support member 11 is coupled to a wheel house panel 21 such that the leg connection part 19, the second leg part 17 and the first leg part 15 of the suspension support member 11 are connected to each other, forming a space between the suspension support member 11 and the wheel house panel 21.

Therefore, the suspension support member 11, together with the wheel house panel 21, forms a shape in which a cross-section containing a space extends from the first leg part 15 to the second leg part 17, such that the suspension support member 11 may serve as a structure with high rigidity.

For reference, the suspension support member 11 may support a shock absorber of a double wishbone type suspension device or the like.

A rear portion 10 of the front side member 9 is coupled to the incline part 3. A side support longitudinal member 23 is further provided to support the rear portion of the front side member 9, provided to overlap the front side member 9 with the incline part 3 interposed therebetween, and elongated in the longitudinal direction along the inclination of the incline part 3.

In other words, the rear portion 10 of the front side member 9 may be securely supported by the side support longitudinal member 23 and the incline part 3 of the dash panel 7 and configured to effectively support an impact force transmitted through the front side member 9 in the event of a frontal collision accident of the vehicle.

A dash upper cross member 25 is provided at a boundary between the upright part 5 and the incline part 3 of the dash panel 7 and elongated in a transverse direction of the vehicle body. The dash upper cross member 25 is structured and installed to overlap the suspension support member 11 with the dash panel 7 interposed therebetween to support a rear upper side of the suspension support member 11.

In other words, the dash upper cross member 25 is installed at a rear side of a portion of the suspension support member 11 to which the leg connection part 19 and the second leg part 17 are connected with the dash panel 7 interposed therebetween. The dash upper cross member 25 is configured to support an impact force transmitted rearward through the suspension support member 11 and inhibit the incline part 3 of the dash panel 7 from being lifted upward.

In one embodiment, a dash middle cross member 27 is provided at a position spaced apart rearward and downward from the dash upper cross member 25, elongated in the transverse direction of the vehicle body, and coupled to the incline part 3. The inclined upper longitudinal member 13 is installed to connect the dash upper cross member 25 and the dash middle cross member 27.

In addition, the dash middle cross member 27 is disposed to overlap a rear upper side of the front side member 9 with the incline part 3 interposed therebetween to support the rear portion of the front side member 9.

In addition, a plurality of inclined lower longitudinal members 29 is connected to the dash middle cross member 27, elongated in the longitudinal direction along the inclination of the incline part 3, and connected to the floor 1 from the dash middle cross member 27.

In this case, the dash middle cross member 27 and the plurality of inclined lower longitudinal members 29 may be integrated.

In other words, the dash middle cross member 27 and the plurality of inclined lower longitudinal members 29 may be manufactured in a shape of a single component by a single press mold.

In the event of a frontal collision accident of the vehicle, the dash middle cross member 27 and the plurality of inclined lower longitudinal members 29, together with the dash upper cross member 25, serve to effectively inhibit the incline part 3 of the dash panel 7 from being deformed while being lifted upward by an impact force inputted rearward through the front side member 9 and the suspension support member 11.

In the present embodiment, the plurality of inclined lower longitudinal members 29 may be provided in pairs (e.g., two pairs on each side) on opposite sides based on a center of the vehicle body based on the transverse direction center. The side support longitudinal member 23 is disposed between the two inclined lower longitudinal members 29 at any one side based on the center of the vehicle body based on the transverse direction.

In addition, a rear end of the side support longitudinal member 23 has a structure connected to and supported by a dash lower cross member 31 installed to be elongated in the transverse direction of the vehicle body configured to connect the two adjacent inclined lower longitudinal members 29.

Therefore, the impact force transmitted rearward through the front side member 9 is supported by the dash panel 7 and the side support longitudinal member 23. The two inclined lower longitudinal members 29 support the dash panel 7 on the opposite sides of the periphery of the side support longitudinal member 23, and the rear end of the side support longitudinal member 23 is connected to the dash lower cross member 31. As a result, the side support longitudinal member 23 and the inclined lower longitudinal member 29 and the dash lower cross member 31, which are provided at the periphery of the side support longitudinal member 23, may effectively disperse and support the impact force transmitted through the front side member 9.

In one embodiment, a seat mounting member 33, which is elongated in the longitudinal direction of the vehicle body, may be connected to the rear end of each of the inclined lower longitudinal members 29.

Therefore, under normal conditions, the inclined lower longitudinal member 29, connected to the seat mounting member 33, helps ensure the rigidity required for seat mounting. In the event of an accident such as a frontal collision of the vehicle, the seat mounting member 33 disperses an impact force, which is transmitted through the inclined lower longitudinal member 29, to the floor 1 and the seat, thereby ensuring higher support rigidity.

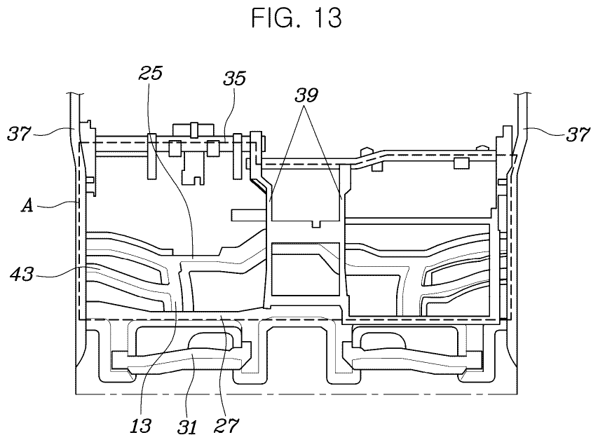

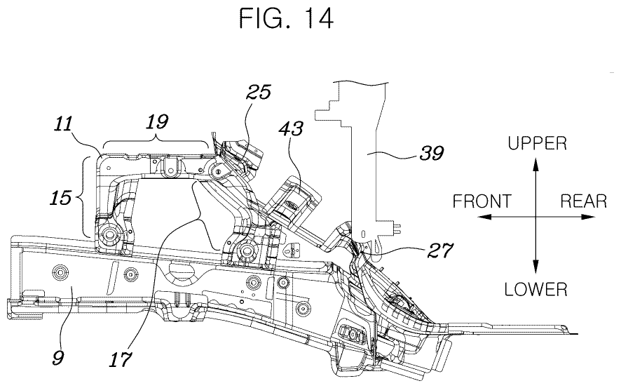

With reference to FIGS. 13 and 14, a cowl cross bar 35 is coupled to an upper side of the dash middle cross member 27 and elongated in the transverse direction of the vehicle body. Two opposite ends of the cowl cross bar 35 are coupled to an A-pillar 37.

In other words, the cowl cross bar 35, the dash middle cross member 27, and the A-pillar 37 constitute an annular structure A toward a front side of the vehicle.

Therefore, the annular structure A made by connecting the cowl cross bar 35, the dash middle cross member 27, and the A-pillar 37 may provide high rigidity for supporting the dash middle cross member 27 downward, thereby more effectively inhibiting the dash panel 7 from being deformed while being lifted rearward by an impact force inputted rearward through the side member and the suspension support member 11 in the event of a frontal collision accident.

In addition, the annular structure A may greatly assist in ensuring rigidity of the front portion of the vehicle body and ensure structural rigidity capable of effectively supporting an impact force even in the event of a broadside collision of the vehicle body.

For reference, a steering column may be fixed to the cowl cross bar 35.

In one embodiment, the cowl cross bar 35 is coupled to the dash middle cross member 27 by at least one cowl support member 39 configured to connect the cowl cross bar 35 and the dash middle cross member 27 upward and downward and support the cowl cross bar 35 and the dash middle cross member 27.

Therefore, when a force is applied to lift the dash panel 7 upward by an impact force transmitted rearward by a frontal collision accident or the like of the vehicle, the cowl support member 39 serves to press the dash panel 7 downward, thereby more effectively inhibiting the dash panel 7 from being lifted upward.

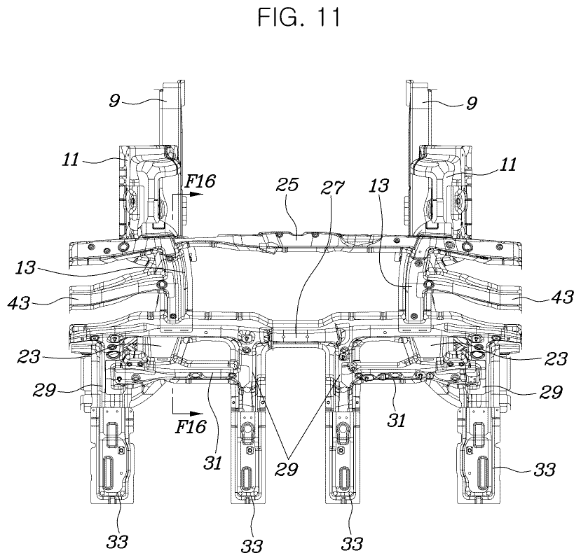

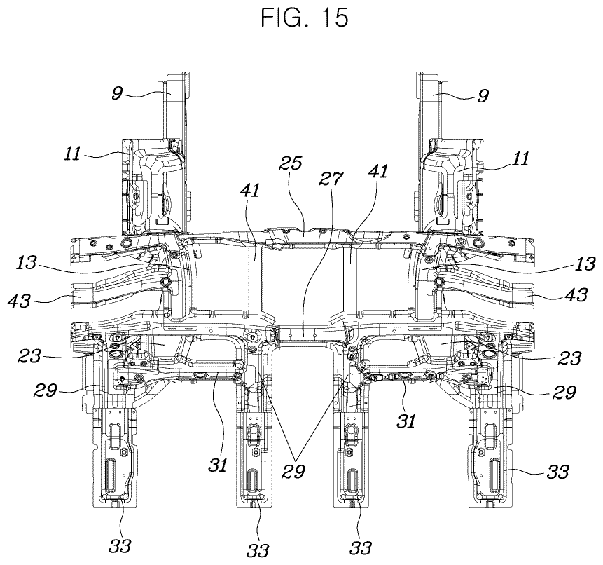

In another embodiment of the present disclosure, as illustrated in FIG. 15 made by modifying FIG. 11, an additional inclined upper longitudinal member 41 may be further provided between the two inclined upper longitudinal members 13 and elongated in the longitudinal direction along the inclination of the incline part 3 to connect the dash upper cross member 25 and the dash middle cross member 27.

In this case, the additional inclined upper longitudinal member 41 may be rectilinearly aligned and disposed at the front upper sides of the two inclined lower longitudinal members 29 close to the center of the vehicle body based on the transverse direction among the plurality of inclined lower longitudinal members 29.

This configuration serves to additionally ensure rigidity of the central portion of the dash panel 7 and further reduce a deformation amount of the dash panel 7 in the event of a frontal collision accident or the like.

An additional dash cross member 43, which has a shape elongated toward the outside of the vehicle body in the transverse direction between the dash upper cross member 25 and the dash middle cross member 27, is connected to each of the two inclined upper longitudinal members 13, such that the additional dash cross member 43 may also disperse and support an impact force transmitted rearward in the event of a frontal collision accident or the like of the vehicle.

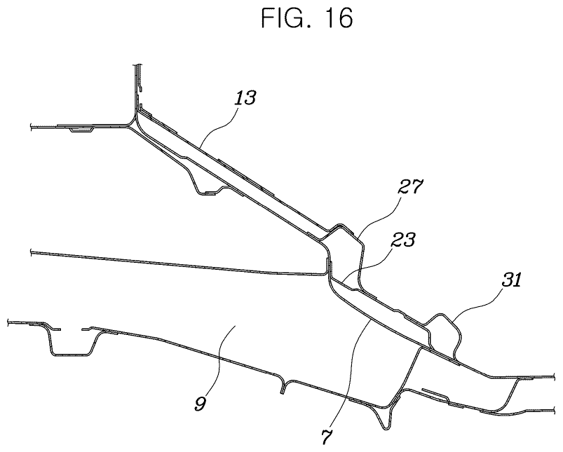

FIG. 16 is a cross-sectional view taken along line F16-F16 in FIG. 11 and illustrates that the side support longitudinal member 23 is installed rearward of the front side member 9. The rear end of the inclined upper longitudinal member 13 is connected to the dash middle cross member 27 without being connected directly to the side support longitudinal member 23.

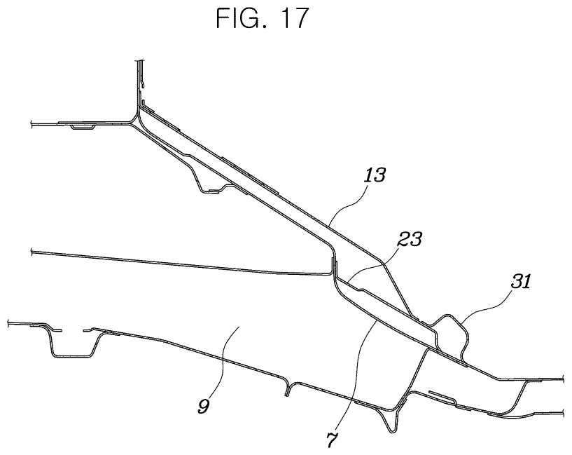

FIG. 17 illustrates another embodiment of the present disclosure made by modifying the configuration in the FIG. 16.

In FIG. 17, the inclined upper longitudinal member 13 is coupled to extend to overlap the upper side of the side support longitudinal member 23, and the rear portion of the front side member 9 is configured to be supported by a dual closed cross-section made by the side support longitudinal member 23 and the inclined upper longitudinal member 13.

This configuration may provide higher rigidity against the impact force transmitted rearward through the front side member 9 and more effectively prevent the dash panel 7 from being lifted upward.

While the specific embodiments of the present disclosure have been illustrated and described, it should be obvious to those having ordinary skill in the art that the present disclosure may be variously modified and changed without departing from the technical spirit of the present disclosure defined in the appended claims.

What is claimed is:

1. A vehicle body structure comprising:
a dash panel including: an incline part extending to be inclined forward and upward from a floor, and an upright part extending upward from the incline part;
front side members disposed on two opposite front sides of a vehicle body and extended in a longitudinal direction of the vehicle body;
a suspension support member disposed on an upper side of the front side member, configured to support a suspension device, and including a rear portion supported on the incline part; and
an inclined upper longitudinal member configured to support the rear portion of the suspension support member, disposed to overlap the suspension support member with the incline part interposed therebetween, and extended in the longitudinal direction along an inclination of the incline part.

2. The vehicle body structure of claim 1, further comprising a side support longitudinal member configured to support the rear portion of the front side member,
wherein a rear portion of the front side member is coupled to the incline part, and
wherein the side support longitudinal member is further configured to overlap the front side member with the incline part interposed therebetween and extend in the longitudinal direction along the inclination of the incline part.

3. The vehicle body structure of claim 2, further comprising a dash upper cross member disposed at a boundary between the upright part and the incline part of the dash panel and configured to extend in a transverse direction of the vehicle body, and
wherein the dash upper cross member is configured to overlap the suspension support member with the dash panel interposed therebetween to support a rear upper side of the suspension support member.

4. The vehicle body structure of claim 3, further comprising:
a dash middle cross member spaced apart rearward and downward from the dash upper cross member, extended in the transverse direction of the vehicle body, and coupled to the incline part,
wherein the inclined upper longitudinal member is configured to connect the dash upper cross member and the dash middle cross member.

5. The vehicle body structure of claim 4, wherein the dash middle cross member is disposed to overlap a rear upper side of the front side member with the incline part interposed therebetween to support the rear portion of the front side member.

6. The vehicle body structure of claim 4, further comprising a plurality of inclined lower longitudinal members connected to the dash middle cross member, extended in the longitudinal direction along the inclination of the incline part, and connected to the floor from the dash middle cross member.

7. The vehicle body structure of claim 6, wherein the dash middle cross member and the plurality of inclined lower longitudinal members are integrated.

8. The vehicle body structure of claim 6, wherein the plurality of inclined lower longitudinal members is provided in two pairs, respectively, on opposite sides based on a center of the vehicle body based on the transverse direction, and
wherein the side support longitudinal member is disposed between the two inclined lower longitudinal members on any one side based on the center of the vehicle body based on the transverse direction.

9. The vehicle body structure of claim 8, wherein a rear end of the side support longitudinal member is connected to and supported by a dash lower cross member installed to be extended in the transverse direction of the vehicle body configured to connect the two adjacent inclined lower longitudinal members.

10. The vehicle body structure of claim 8, wherein a seat mounting member is connected to a rear end of each of the inclined lower longitudinal members and extended in the longitudinal direction of the vehicle body.

11. The vehicle body structure of claim 6, further comprising a cowl cross bar coupled to an upper side of the dash middle cross member and extended in the transverse direction of the vehicle body, and
wherein two opposite ends of the cowl cross bar are coupled to an A-pillar.

12. The vehicle body structure of claim 11, wherein the cowl cross bar, the dash middle cross member, and the A-pillar constitute an annular structure toward a front side of the vehicle.

13. The vehicle body structure of claim 11, wherein the cowl cross bar is coupled to the dash middle cross member by at least one cowl support member configured to connect the cowl cross bar and the dash middle cross member upward and downward and support the cowl cross bar and the dash middle cross member.

14. The vehicle body structure of claim 8, wherein an additional inclined upper longitudinal member is further provided between the two inclined upper longitudinal members and extended in the longitudinal direction along the inclination of the incline part to connect the dash upper cross member and the dash middle cross member.

15. The vehicle body structure of claim 14, wherein the additional inclined upper longitudinal member is rectilinearly aligned and disposed on front upper sides of the two inclined lower longitudinal members close to the center of the vehicle body based on the transverse direction among the plurality of inclined lower longitudinal members.

16. The vehicle body structure of claim 8, wherein an additional dash cross member, which has a shape elongated toward an outside of the vehicle body in the transverse direction between the dash upper cross member and the dash middle cross member, is connected to each of the two inclined upper longitudinal members.

17. The vehicle body structure of claim 2, wherein the inclined upper longitudinal member is coupled to extend to overlap the upper side of the side support longitudinal member, and
wherein the rear portion of the front side member is configured to be supported by a dual closed cross-section made by the side support longitudinal member and the inclined upper longitudinal member.

18. The vehicle body structure of claim 1, wherein the suspension support member is formed in an ‘n’ shape in which two opposite ends thereof are coupled to be spaced apart from the front side member in the longitudinal direction.

19. The vehicle body structure of claim 1, wherein the suspension support member comprises:
a first leg part having a lower end coupled to the front side member;
a second leg part having a lower end coupled to the front side member at a rear side of the first leg part; and
a leg connection part extended in the longitudinal direction of the vehicle body and configured to connect the first leg part and an upper end of the second leg part.

20. The vehicle body structure of claim 19, wherein the suspension support member is coupled to a wheel house panel such that the leg connection part, the second leg part, and the first leg part of the suspension support member are connected to each other, forming a space between the suspension support member and the wheel house panel.
